(19) United States
(12) Patent Application Publication
(10) Pub. No.: US 2026/0113209 A1
(43) Pub. Date: Apr. 23, 2026

(54) Conferencing System Terminal Devices and Corresponding Methods Facilitating Interruption of Do Not Disturb Modes of Operation

(71) Applicant: Motorola Mobility LLC, Chicago, IL (US)

(72) Inventors: Amit Kumar Agrawal, Bangalore (IN); Krishnan Raghavan, Bangalore (IN)

(21) Appl. No.: 18/920,944

(22) Filed: Oct. 20, 2024

(51) Int. Cl. H04L 12/18; G10L 15/26

(52) U.S. Cl. CPC H04L 12/1818; G10L 15/26; H04L 12/1822; H04L 12/1831

(57) ABSTRACT

A conferencing system terminal device manages electronic communications during videoconferences while operating in a do not disturb mode. The system detects a communication device in contact with remote devices engaged in the videoconference. The system receives electronic communications and determines their relevance to the videoconference subject matter. If relevant, the system temporarily overrides the do not disturb mode to present the communication on the user interface. This ensures important messages are surfaced without unnecessary interruptions, maintaining focus on the videoconference while allowing responsive engagement.

### BACKGROUND

### Technical Field

This disclosure relates generally to electronic devices, and more particularly to electronic devices capable of providing video conferencing features.

### Background Art

Many modern electronic devices, including smartphones, tablet computers, and laptop computers, are equipped to engage in videoconferences with other electronic devices across a network. Users employ such devices to communicate with friends, family, and work colleagues. This is especially true when people work remotely rather than going to a centralized office.

Participants engage videoconferencing to engage in real-time discussions and share electronic content. Videoconferencing additionally offers participants the ability to see other participants via video feeds streamed to the participating electronic devices. It would be advantageous to have an improved methods, systems, and devices to more seamlessly surface information associated with potential activities that occur within videoconferencing realms.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method and system in accordance with one or more embodiments of the disclosure.

FIG. 2 illustrates one explanatory conferencing system terminal device in accordance with one or more embodiments of the disclosure.

FIG. 3 illustrates one explanatory videoconferencing server in accordance with one or more embodiments of the disclosure.

FIG. 4 illustrates one explanatory method in accordance with one or more embodiments of the disclosure.

FIG. 5 illustrates one or more embodiments of the disclosure.

FIG. 6 illustrates a prior art method.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to detecting, with one or more processors during a videoconference, a communication device electronically in communication with one or more remote electronic devices engaged in the videoconference, receiving, with a communication device operable with the one or more processors, an electronic communication while the videoconference is occurring and the electronic device is operating in a do not disturb mode of operation, determining, by the one or more processors, whether the electronic communication is materially related to subject matter of the videoconference, and where the electronic communication is materially related to the subject matter of the videoconference, temporarily overriding, by the one or more processors, the do not disturb mode of operation for the electronic communication and presenting, by the one or more processors on a user interface of the electronic device, at least some of the electronic communication. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of determining, from signals received from one or more sensors when an electronic communication is received by the communication device while an electronic device is operating in a do not disturb mode of operation, subject matter of an activity engaged in by an authorized user of the electronic device and other subject matter of the electronic communication and, when the subject matter of the activity and the other subject matter of the electronic communication are correlated, temporarily suspend the do not disturb mode of operation to cause the user interface to present at least some of the electronic communication as described herein. The non-processor circuits may include, but are not limited to, a radio receiver, a radio transmitter, signal drivers, clock circuits, power source circuits, and user input devices.

As such, these functions may be interpreted as steps of a method to perform determining, by one or more sensors, that an authorized user of the electronic device is engaged in an activity while the electronic device is operating in a do not disturb mode of operation and receiving, by a communication device while the authorized user of the electronic device is engaged in the activity and the electronic device is operating in the do not disturb mode of operation, an electronic communication. In one or more embodiments, the method further comprises determining, by one or more processors, a subject of the activity, another subject of the electronic communication, and whether the electronic communication was received from a remote electronic device belonging to another authorized user of the remote electronic device also engaged in the activity. In one or more embodiments, when the subject of the activity and the another subject of electronic communication are correlated and the electronic communication was received from the remote electronic device belonging to the another authorized user of the remote electronic device also engaged in the activity, the method comprises causing, by the one or more processors, a user interface to present at least some of the electronic communication.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on. ” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that during video conferences, users often activate the “Do not disturb” (DND) mode to prevent interruptions and maintain focus. This practice becomes important when sharing screens, ensuring no notifications or incoming messages disrupt the shared content. Without activating DND, users risk distractions that can impede the flow of the meeting. Incoming messages, notifications, or calls might inadvertently appear on-screen, disrupting the presentation and potentially sharing sensitive or irrelevant information. This could lead to embarrassment or loss of concentration during significant discussions. Moreover, personal or confidential messages might inadvertently be shared with attendees, compromising privacy and professionalism.

While activating do not disturb during video calls helps users avoid external disruptions, embodiments of the disclosure also contemplate that activating the do not disturb mode of operation can inadvertently lead to missing important communications from call participants themselves. In the pursuit of an uninterrupted session, users might overlook messages or cues from fellow participants occurring in parallel. This oversight can result in missed opportunities to address queries, provide timely input, or collaborate effectively during the call. Participants might need to share information, seek clarification, or contribute to the discussion, and if someone on do not disturb misses these interactions, missing these interactions can hinder the overall productivity and outcome of the meeting. Balancing uninterrupted concentration with responsive engagement remains a challenge in leveraging do not disturb effectively during video conferences.

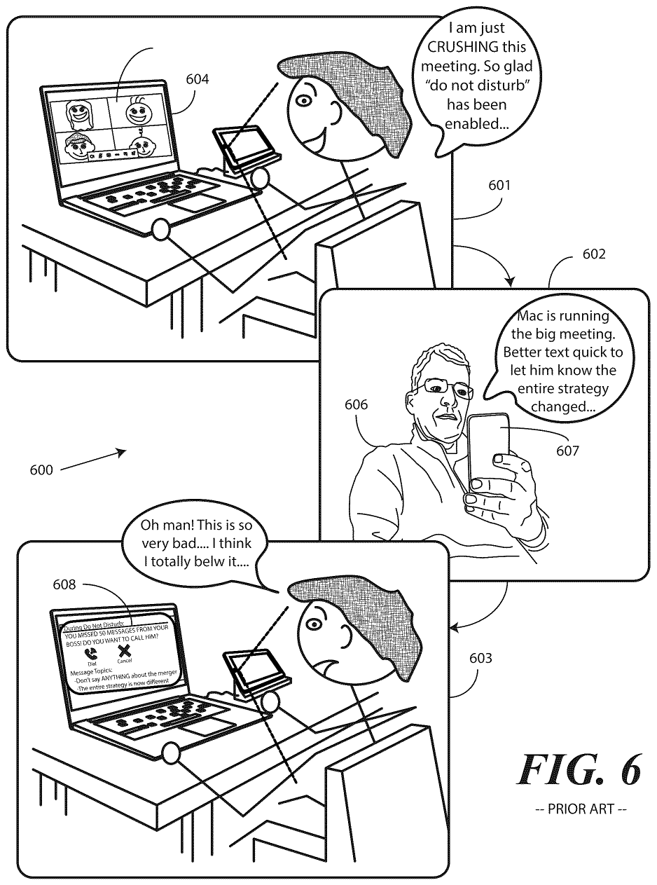

Illustrating by example, turn now briefly to FIG. 6 where a prior art method 600 is illustrated. At step 601, a user named Mac is engaged in a videoconference 605 using a conferencing system terminal device 604, which in this illustrative embodiment is a laptop computer. During the videoconference 605, Mac engages in a meeting with internal team members and an external partner. At step 601, Mac activates the do not disturb mode to maintain focus and prevent interruptions.

Thus, at step 601 Mac engages in the videoconference 605 using the conferencing system terminal device 604. The conferencing system terminal device 604 operates with the “Do not disturb” mode activated, allowing Mac to maintain focus and deliver a seamless presentation.

The system effectively manages incoming communications, ensuring that only relevant messages related to the ongoing discussion surface, thereby preventing unnecessary interruptions. This functionality enables Mac to concentrate on the content and flow of the meeting without distractions.

At step 601, he internal team members and external partner express satisfaction with Mac's presentation. The conferencing system terminal device 604 facilitates a smooth exchange of information, enhancing the overall experience for all participants. The device's ability to selectively override the “Do not disturb” mode for pertinent communications ensures that Mac remains responsive to inputs without compromising the meeting's focus. This balance of concentration and engagement contributes to the participants' positive reception of the presentation. Things are going so smoothly that Mac thinks to himself, “I am CRUSHING this meeting. So glad ‘do not disturb’ has been enabled . . . .”

Unfortunately, while the videoconference 605 progresses, Mac receives several messages from his skip-level manager and direct supervisor, Buster 606. At step 602, Buster 606, Mac's skip-level manager and direct supervisor, utilizes electronic device 607 in an effort to communicate with Mac. Buster 606 aims to inform Mac of a significant shift in strategy, emphasizing that the revised approach remains confidential and not be disclosed to the internal team or the external partner. The new narrative suggests a departure from the initial acquisition plan of the external partner. The strategy now reflects a position of indecision, driven by findings from due diligence.

In this illustrative example, the due diligence process has revealed that the external partner has been inconsistent in paying maintenance fees on their patent portfolio. This portfolio notably includes numerous patents related to pizza making, which adds a layer of complexity to the situation. The discovery of these lapses in fee payments raises concerns about the external partner's reliability and financial stability, prompting a reevaluation of the potential acquisition. The narrative shift underscores the importance of maintaining discretion and reassessing the strategic direction in light of these new insights.

Sadly, during the videoconference 605, Mac's conferencing system terminal device 604 operates in a do not disturb mode of operation. This setting prevents any incoming messages from reaching Mac while the meeting progresses. As a result, Mac remains unaware of communications from his skip-level manager and direct supervisor, Buster 606, who attempts to convey a significant shift in strategy. This oversight leads Mac to inadvertently disclose sensitive information regarding the acquisition.

Unbeknownst to Mac, the external partner's patent portfolio, which includes a patent directed to micro-embedding micro tomatoes into the pores of cheese, faces issues due to a failure to pay a maintenance fee. This lapse has resulted in the patent being dedicated to the public, raising concerns about the external partner's reliability and financial stability. The lack of timely communication prevents Mac from adjusting his presentation to reflect the revised strategy, which emphasizes confidentiality and a reevaluation of the acquisition plan.

The do not disturb mode, while intended to maintain focus, inadvertently isolates Mac from receiving updates. At step 603, upon the conclusion of the videoconference 605, Mac receives a do not disturb message summary 608. This summary indicates that Mac has missed fifty messages from Buster 606. The messages include topics such as “do not say anything about the merger” and “the strategy is now different.” The realization of these missed communications highlights the significant oversight that occurred during the meeting.

The inadvertent disclosure of sensitive information during the videoconference has led to a substantial impact on the external partner's stock, which has now fallen by twenty-five percent. This outcome underscores the importance of timely communication and the consequences of failing to override the do not disturb mode for relevant messages. The situation reflects the challenges faced in maintaining focus while ensuring engagement with pertinent communications during video conferences.

The aftermath of the disclosure has left Mac in a state of concern, as the repercussions extend beyond the professional realm. The impact on the external partner's stock has caused dismay among Mac's friends and family, who are now aware of the situation. The incident serves as a reminder of the delicate balance required in managing communication settings during discussions. This situation also underscores the challenge of balancing concentration with responsive engagement during video conferences.

Advantageously, embodiments of the disclosure address this issue by detecting incoming communications and determining their relevance to the ongoing discussion, allowing for selective overriding of the do not disturb mode to ensure messages are surfaced without disrupting the meeting flow. In one or more embodiments, embodiments of the disclosure detect incoming communications during a videoconference and determining their relevance to the ongoing discussion. When the communication is materially related to the subject matter of the videoconference, the method temporarily overrides the do not disturb mode, ensuring that messages are surfaced to the user without disrupting the meeting flow.

In one or more embodiments, a method in an electronic device involves detecting, with one or more processors during a videoconference, a communication device electronically in communication with one or more remote electronic devices engaged in the videoconference. In one or more embodiments, the method includes receiving, with a communication device operable with the one or more processors, an electronic communication while the videoconference is occurring, and the electronic device is operating in a do not disturb mode of operation.

In one or more embodiments, the method further involves determining, by the one or more processors, whether the electronic communication is materially related to the subject matter of the videoconference. In one or more embodiments, when the electronic communication is materially related to the subject matter of the videoconference, the method temporarily overrides, by the one or more processors, the do not disturb mode of operation for the electronic communication and presents, by the one or more processors on a user interface of the electronic device, at least some of the electronic communication.

Advantageously, embodiments of the disclosure allow for the detection of electronic communications during a videoconference while the device is in a do not disturb mode of operation, thereby ensuring that only communications materially related to the videoconference are surfaced. This selective overriding of the do not disturb mode prevents unnecessary interruptions while maintaining the user's focus on relevant discussions, thereby enhancing productivity and engagement during the call.

By determining the relevance of incoming communications to the subject matter of the videoconference, the method ensures that important messages are not missed, addressing the challenge of balancing concentration with responsive engagement. This approach provides a practical solution to the problem of missing critical communications from call participants, which can hinder meeting outcomes.

The method's implementation involves using processors to assess the relationship between the communication and the videoconference content, allowing for a temporary suspension of the do not disturb mode. This ensures that the user interface presents pertinent communications without disrupting the meeting flow, thereby improving the overall user experience and maintaining the confidentiality of shared content.

In one or more embodiments, a method in an electronic device comprises detecting, with one or more processors during a videoconference, a communication device electronically in communication with multiple remote electronic devices engaged in the videoconference. The system identifies when the user has enabled a do not disturb setting. In one or more embodiments, upon detecting an incoming chat communication, the system determines if the communication originates from an active participant in the current video conference call. The system further assesses whether the incoming chat is related to the topic being discussed in the video call.

In response to receiving an incoming chat communication from another active participant, in one or more embodiments the system temporarily overrides the do not disturb setting to surface the communication. If the device screen is shared, the system ensures that the incoming communication appears in a private mode, preventing the incoming communication from being shared with other participants. The execution of these steps depends on user settings configured for the selective do not disturb override feature.

In one or more embodiments, an electronic device comprises one or more sensors, a communication device, a user interface, and one or more processors. In one or more embodiments, the processors operate in conjunction with the sensors, communication device, and user interface to manage electronic communications received while the device functions in a do not disturb mode.

In one or more embodiments, the processors determine the subject matter of an activity engaged in by an authorized user and the subject matter of the electronic communication. In one or more embodiments, when the subject matter of the activity and the electronic communication correlate, the processors temporarily suspend the do not disturb mode to present at least some of the electronic communication on the user interface.

In one or more embodiments, the sensors detect signals that inform the processors about the activity the user is engaged in, allowing the system to assess whether the incoming communication is relevant. The communication device facilitates the reception of electronic communications, while the user interface displays the relevant communications to the user. This configuration ensures that important messages are surfaced without disrupting the user's focus, maintaining the balance between concentration and engagement during activities such as videoconferences.

Advantageously, this configuration allows the device to temporarily suspend the do not disturb mode when the subject matter of the activity and the communication are correlated, ensuring that relevant communications are presented to the user. This arrangement enhances user engagement by allowing important messages to be surfaced without unnecessary interruptions, maintaining focus on relevant discussions during activities such as videoconferences.

The integration of sensors and processors enables the device to intelligently assess the context of both the user's activity and incoming communications. By correlating these contexts, the device can selectively override the do not disturb mode, ensuring that only pertinent communications are displayed. This capability addresses the challenge of missing critical communications during focused activities, thereby improving productivity and collaboration.

In one or more embodiments, a method in an electronic device involves determining, by one or more sensors, that an authorized user of the electronic device is engaged in an activity while the electronic device operates in a do not disturb mode. In one or more embodiments, the method includes receiving, by a communication device, an electronic communication while the authorized user is engaged in the activity and the device is in the do not disturb mode. In one or more embodiments, the method further involves determining, by one or more processors, a subject of the activity, another subject of the electronic communication, and whether the electronic communication was received from a remote electronic device belonging to another authorized user also engaged in the activity.

In one or more embodiments, when the subject of the activity and the subject of the electronic communication are correlated, and the communication was received from the remote electronic device belonging to another authorized user also engaged in the activity, the method causes, by the one or more processors, a user interface to present at least some of the electronic communication. This ensures that relevant communications are surfaced to the user without unnecessary interruptions, maintaining focus on the activity while allowing for responsive engagement.

Illustrating by example, in one or more embodiments the method can determine the subject of an activity by detecting an activity of the electronic device. This detection process utilizes one or more sensors to ascertain the nature of the activity in which the authorized user is engaged. The sensors provide signals to the processors, enabling the system to identify the context of the user's engagement while the device operates in a do not disturb mode.

In this method, the processors analyze the signals received from the sensors to determine the specific activity being performed. This analysis allows the system to correlate the subject of the activity with the subject of any incoming electronic communication. When a correlation exists, the processors temporarily suspend the do not disturb mode, ensuring that relevant communications are presented to the user on the user interface.

This approach ensures that the user remains informed of pertinent communications without unnecessary interruptions, maintaining focus on the activity while allowing for responsive engagement. The method enhances the functionality of the electronic device by intelligently managing communication settings based on the detected activity, thereby improving user experience and productivity.

Advantageously, by using sensors to detect the activity and processors to determine the subject of both the activity and any incoming electronic communication, the system can correlate these subjects to decide if the communication should be surfaced. This ensures that relevant communications are presented to the user without unnecessary interruptions, maintaining focus on the activity while allowing for responsive engagement.

Embodiments of the disclosure enhance user experience by intelligently managing communication settings based on the detected activity, thereby improving productivity and collaboration. For example, if a user is in a videoconference, the system can transcribe speech or receive user input to define the subject of the activity, ensuring that only pertinent communications are surfaced. This prevents the user from missing critical communications from other participants engaged in the same activity, addressing the challenge of balancing concentration with engagement.

This approach allows users like Mac to remain engaged with pertinent communications while maintaining the focus and privacy intended by the do not disturb setting. By selectively overriding the do not disturb mode for relevant communications, embodiments of the disclosure enhance productivity and collaboration during videoconferences, ensuring that users do not miss contributions or questions from other participants. Other advantages will be described below. Still others will be obvious to those of ordinary skill in the art having the benefit of this disclosure.

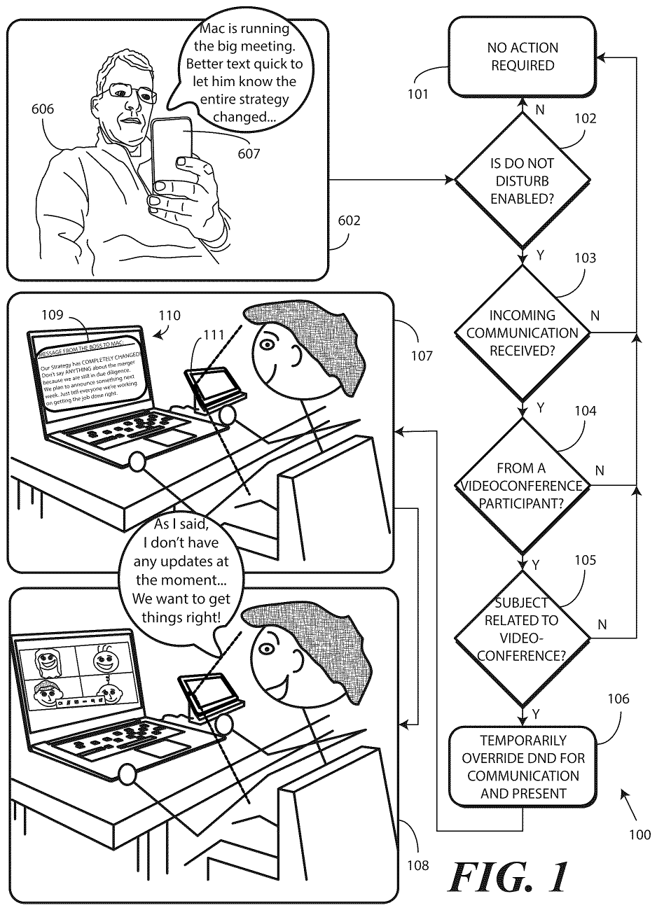

To see how methods, electronic devices, and corresponding systems described above can work, turn now to FIG. 1. Beginning again at step 602, Buster 606, Mac's skip-level manager and direct supervisor, once again utilizes his electronic device 607 in an effort to communicate with Mac. Buster 606 again aims to inform Mac of a significant shift in strategy, emphasizing that the revised approach remains confidential and not be disclosed to the internal team or the external partner. Due diligence has again revealed that the external partner has been inconsistent in paying maintenance fees on their patent portfolio, which notably includes the numerous patents related to pizza making, thereby a layer of complexity to the situation.

Fortunately, Mac is equipped with a conferencing system terminal device 110 configured in accordance with one or more embodiments of the disclosure. Decision 102 first detects, with one or more processors of the conferencing system terminal device 110 during eth videoconference, whether a communication device of the conferencing system terminal device 110 is electronically in communication with one or more embodiments remote electronic devices engaged in the videoconference. Where it is, decision 102 also determines whether the conferencing system terminal device 110 is operating in a do not disturb mode of operation. Where both situations are true, the method 100 moves to decision 103. Otherwise, the conferencing system terminal device 110 takes no action at step 101.

Decision 103 determines whether the communication device operable with the conferencing system terminal device 110 receives an electronic communication while the videoconference is occurring. Where it is, the method 100 moves to decision 104. Otherwise, the method 100 takes no action at step 101.

Decision 104 determines, by one or more processors of the conferencing system terminal device 110, whether the electronic communication is materially related to the subject matter of the of the videoconference. This decision can occur in a variety of ways.

In one or more embodiments, decision 104 comprises determining whether the electronic communication is materially related to the subject matter of the videoconference by determining whether the electronic communication is received from a remote electronic device engaged in the videoconference. Said differently, in one or more embodiments decision 104 determines whether the electronic communication was received from another person engaged in the videoconference. Illustrating by example, in one or more embodiments the electronic communication can comprise a chat conversation from another videoconference participant.

In the illustrative example of FIG. 1, this is the case. Consequently, the method 100 moves to decision 105. In one or more embodiments, decision 105 can comprise determining whether the electronic communication is materially related to the subject matter of the videoconference by determining whether a subject of the electronic communication is materially related to the subject matter of the videoconference.

In the illustrative example of FIG. 1, this is certainly the case as the topic of conversation is an acquisition of the external partner and the electronic communication instructs Mac not to discuss the acquisition because the strategy has changed. Consequently, the method 100 moves to step 106.

In one or more embodiments, step 106 comprises, where the electronic communication is materially related to the subject matter of the videoconference, temporarily overriding, by the one or more processors, the do not disturb mode of operation for the electronic communication and presenting, by the one or more processors on a user interface of the electronic device, at least some of the electronic communication. In one or more embodiments, the presenting the at least some of the electronic communication at step 106 comprises presenting the at least some of the electronic communication on a display of the conferencing system terminal device 110.

In one or more embodiments, the presenting the at least some of the electronic communication at step 106 comprises presenting the at least some of the electronic communication on only the display of the conferencing system terminal device 110 to whom the electronic communication was sent without presenting the at least some of the electronic communication on any of the one or more remote electronic devices engaged in the videoconference. As shown at step 107, this allows Mac to see the at least some of the electronic communication 109 on the display of his conferencing system terminal device 110 without the internal team or external partner seeing the same.

While step 106 has presented the at least some of the electronic communication 109 on the conferencing system terminal device 110 Mac is using to engage in the videoconference, embodiments of the disclosure are not so limited. Indeed, embodiments of the disclosure contemplate that Mac may have a companion electronic device 111 that is operable with the conferencing system terminal device 110, examples of which include a smartphone, tablet, smartwatch, or other companion electronic device. Accordingly, in other embodiments, step 106 can comprise presenting the at least some of the electronic communication 109 on a display of a companion electronic device 111 in communication with the conferencing system terminal device 110.

Step 107 results in the presentation of at least some of the electronic communication 109 on the display of the conference system terminal device 110. This immediate notification apprises Mac of the strategic shift regarding the acquisition of the external partner. Mac can employ several strategies to redirect the conversation without disclosing sensitive information. One approach involves Mac acknowledging the need for further internal review before proceeding with the discussion. This technique maintains the attention of both the internal team and the external partner by emphasizing the importance of thorough analysis.

Another strategy involves Mac steering the conversation towards exploring alternative collaboration opportunities with the external partner. By focusing on potential synergies, Mac can engage both parties in a constructive dialogue that aligns with the revised strategy. Additionally, Mac might suggest scheduling a follow-up meeting to delve deeper into specific aspects of the partnership, thereby buying time to align with the new strategic direction. Each of these approaches allows Mac to maintain control of the conversation while ensuring that the internal team and external partner remain engaged and focused on productive outcomes.

At step 108, Mac elects to redirect the conversation by emphasizing the meticulous approach his company employs in evaluating strategic actions before reaching decisions. This redirection allows Mac to conclude the meeting effectively, maintaining the confidentiality of sensitive information. The strategic shift in conversation underscores the importance of thorough analysis and careful consideration in corporate decision-making processes.

Following the successful conclusion of the meeting, Mac plans to visit Henry and Chuck's restaurant, renowned for serving chicken biscuits throughout the day. Mac intends to order a particularly distinguished type of chicken biscuit, reflecting his satisfaction with the outcome of the meeting. The conferencing system terminal device 110, configured in accordance with embodiments of the disclosure, played a role in ensuring that Mac did not inadvertently disclose any sensitive information during the videoconference.

Advantageously, the disclosed method 100 addresses the challenge of maintaining focus during video conferences while ensuring communications are not missed. In one or more embodiments, the method 100 involves detecting, with one or more processors during a videoconference, a communication device electronically in communication with remote electronic devices engaged in the videoconference. The method further includes receiving an electronic communication while the videoconference is occurring, and the electronic device is operating in a do not disturb mode. By determining whether the electronic communication is materially related to the subject matter of the videoconference, the method temporarily overrides the do not disturb mode for the electronic communication, presenting the electronic communication on a user interface. This approach ensures that users remain engaged with relevant communications without compromising the focus and privacy intended by the do not disturb setting.

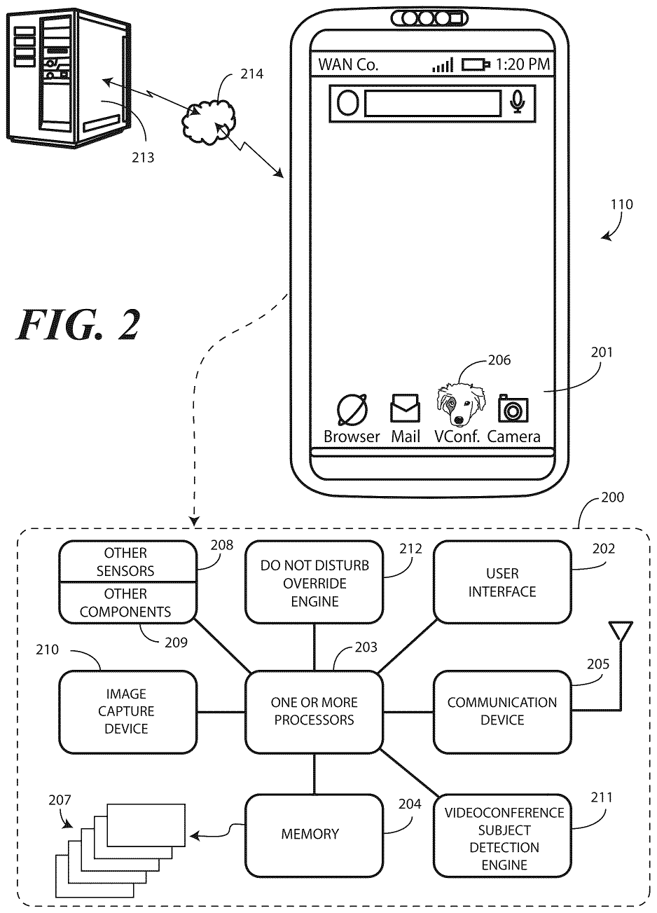

Turning now to FIG. 2, illustrated therein is one explanatory conferencing system terminal device 110 configured in accordance with one or more embodiments of the disclosure. In one or more embodiments, the conferencing system terminal device 110 can be in communication with a conferencing system server complex 213 across a network 214 when the conferencing system terminal device 110 is engaged in a videoconference.

The conferencing system terminal device 110 of FIG. 2 is a portable electronic device. For illustrative purposes, the conferencing system terminal device 110 is shown as a smartphone. However, the conferencing system terminal device 110 could be any number of other devices as well, including tablet computers, desktop computers, notebook computers, and so forth. Still other types of conferencing system terminal devices can be configured in accordance with one or more embodiments of the disclosure as will be readily appreciated by those of ordinary skill in the art having the benefit of this disclosure.

This illustrative conferencing system terminal device 110 includes a display 201, which may optionally be touch-sensitive. In one embodiment where the display 201 is touch-sensitive, the display 201 can serve as a primary user interface 202 of the conferencing system terminal device 110. Users can deliver user input to the display 201 of such an embodiment by delivering touch input from a finger, stylus, or other objects disposed proximately with the display 201.

In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure. Where the conferencing system terminal device 110 is configured with a keyboard and/or mouse, such as when the conferencing system terminal device 110 is configured as a computer, the keyboard and/or mouse can serve as the primary user interface 202.

A block diagram schematic 200 of the conferencing system terminal device 110 is also shown in FIG. 2. The block diagram schematic 200 can be configured as a printed circuit board assembly disposed within the device housing of the conferencing system terminal device 110. Various components can be electrically coupled together by conductors, or a bus disposed along one or more printed circuit boards.

In one or more embodiments, the conferencing system terminal device 110 includes one or more processors 203. In one embodiment, the one or more processors 203 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the conferencing system terminal device 110. Each of the application processor and the auxiliary processor(s) can be configured to process and execute executable software code to perform the various functions of the conferencing system terminal device 110. A storage device, such as memory 204, can optionally store the executable software code used by the one or more processors 203 during operation.

The conferencing system terminal device 110 also includes a communication device 205 that can be configured for wired or wireless communication with one or more other devices or networks. The networks can include a wide area network, a local area network, and/or personal area network. The communication device 205 may also utilize wireless technology for communication, such as, but are not limited to, peer-to-peer or ad hoc communications such as HomeRF, Bluetooth and IEEE 802.11, and other forms of wireless communication such as infrared technology. The communication device 205 can include wireless communication circuitry, one of a receiver, a transmitter, or transceiver, and one or more antennas.

In one embodiment, the one or more processors 203 can be responsible for performing the primary functions of the conferencing system terminal device 110. For example, in one embodiment the one or more processors 203 comprise one or more circuits operable with one or more user interface devices, which can include the display 201, to engage in videoconferences by transmitting, receiving, and presenting images, video, or other presentation information. The executable software code used by the one or more processors 203, including that associated with a videoconference application 206, can be configured as one or more modules 207 that are operable with the one or more processors 203. Such modules 207 can store instructions, control algorithms, logic steps, and so forth.

In one embodiment, the one or more processors 203 are responsible for running the operating system environment of the conferencing system terminal device 110. The operating system environment can include a kernel and one or more drivers, and an application service layer, and an application layer. The operating system environment can be configured as executable code operating on one or more processors or control circuits of the conferencing system terminal device 110.

The application layer can be responsible for executing application service modules. The application service modules may support one or more applications or “apps,” such as the videoconference application 206. The applications of the application layer can be configured as clients of the application service layer to communicate with services through application program interfaces (APIs), messages, events, or other inter-process communication interfaces. Where auxiliary processors are used, they can be used to execute input/output functions, actuate user feedback devices, and so forth.

In one embodiment, the one or more processors 203 may generate commands or execute control operations based upon user input received at the user interface 202. Moreover, the one or more processors 203 may process the received information alone or in combination with other data, such as the information stored in the memory 204.

The conferencing system terminal device 110 can include one or more sensors 208. The one or more sensors 208 may include a microphone, camera, any of the sensors described above, an earpiece speaker, and/or a second loudspeaker. The one or more other sensors 208 may also include touch actuator selection sensors, proximity sensors, a touch pad sensor, a touch screen sensor, a capacitive touch sensor, and one or more switches.

Touch sensors may be used to indicate whether any of the user actuation targets present on the display 201, including the user actuation targets presented in a prompt facilitating the commencement of a side call as described above, are being actuated. The other sensors 208 can also include audio sensors and video sensors (such as a camera).

Other components 209 operable with the one or more processors 203 can include output components such as video outputs, audio outputs, and/or mechanical outputs. Examples of output components include audio outputs such as speaker port, earpiece speaker, or other alarms and/or buzzers and/or a mechanical output component such as vibrating or motion-based mechanisms. Still other components will be obvious to those of ordinary skill in the art having the benefit of this disclosure.

The other components 209 can also include an image processor. The image processor can include hardware, executable code, and image processing executable code in one embodiment. The image processor can include, stored in memory 204, basic image models, trained image models, or other modules that are used by the image processor to determine whether images captured by the imager include portions depicting obscured portions of a subject depicted in those images. In one embodiment, the image processor can include an object recognition engine. Regardless of the specific implementation utilized in the various embodiments, the image processor can access various image models to determine whether a person is engaged in an activity during a side call that may, for example, trigger the delivery of a video overlay in one or more embodiments.

To capture video during a videoconference, in one or more embodiments the conferencing system terminal device 110 includes an image capture device 210 or another imager. The conferencing system terminal device 110 can optionally include a depth imager as well.

In one embodiment, the image capture device 210 comprises a two-dimensional imager configured to receive at least one image of a person within an environment of the conferencing system terminal device 110. In one embodiment, the image capture device 210 comprises a two-dimensional RGB imager. In another embodiment, the image capture device 210 comprises an infrared imager. Other types of imagers suitable for use as the image capture device 210 of the conferencing system terminal device 110 will be obvious to those of ordinary skill in the art having the benefit of this disclosure.

In one or more embodiments, the conferencing system terminal device 110 includes a videoconference subject detection engine 211. In one or more embodiments, the videoconference subject detection engine 211 is configured to identify the subject matter of a videoconference when the conferencing system terminal device 110 is engaged in a videoconference. Illustrating by example, in one or more embodiments the videoconference subject detection engine 211 can transcribe speech occurring during the videoconference. In other embodiments, the videoconference subject detection engine 211 can ascertain a subject found in a videoconference meeting notification or calendaring invitation stored in a memory 204 of the conferencing system terminal device 110. Still other techniques for the videoconference subject detection engine 211 to determine the subject matter of the videoconference will be obvious to those of ordinary skill in the art having the benefit of this disclosure.

In one or more embodiments, the videoconference subject detection engine 211 determines, from signals received from the one or more sensors 208 when an electronic communication is received by the communication device 205 while the conferencing system terminal device 110 is operating in a do not disturb mode of operation, subject matter of an activity engaged in by an authorized user of the conferencing system terminal device 110 and other subject matter of the electronic communication. Illustrating by example, in one or more embodiments the activity is a videoconference. In one or more embodiments, the videoconference subject detection engine 211 determines a subject of the activity engaged in by the authorized user, another subject of a received electronic communication, and whether the electronic communication was received from a remote electronic device belonging to another authorized user of the remote electronic device also engaged in the activity.

When the activity is the videoconference, and the subject matter of the electronic communication is related to the subject matter of the videoconference, in one or more embodiments a do not disturb override engine 212 temporarily suspends the do not disturb mode of operation and causes the user interface 202 to present at least some of the electronic communication. Said differently, in one or more embodiments when the subject matter of the activity and the other subject matter of the electronic communication are correlated, the do not disturb override engine 212 temporarily suspends the do not disturb mode of operation to cause the user interface 202 to present at least some of the electronic communication.

In one or more embodiments, the do not disturb override engine 212 only causes the user interface 202 to present the at least some of the electronic communication when the electronic communication is received from a remote electronic device engaged in the videoconference. In one or more embodiments, the do not disturb override engine 212 causes the user interface 202 to present the at least some of the electronic communication on the user interface 202 while precluding at least one other remote electronic device engaged in the videoconference from presenting any of the electronic communication. This advantageously ensures that only the videoconference participant to whom the electronic communication was directed sees the electronic communication. As noted above, in other embodiments the do not disturb override engine 212 can cause the at least some of the electronic communication to be presented on the display of a companion electronic device, such as a smartwatch.

Thus, in one or more embodiments the videoconference subject detection engine 211 determines, using one or more sensors 208, that an authorized user of the conferencing system terminal device 110 is engaged in an activity while the conferencing system terminal device 110 is operating in a do not disturb mode of operation. In one or more embodiments. The videoconference subject detection engine 211 receives, using a communication device 205 while the authorized user of the conferencing system terminal device 110 is engaged in the activity and the conferencing system terminal device 110 is operating in the do not disturb mode of operation, an electronic communication.

In one or more embodiments, a videoconference subject detection engine 211 determines a subject of the activity, another subject of the electronic communication, and whether the electronic communication was received from a remote electronic device belonging to another authorized user of the remote electronic device also engaged in the activity. Using the videoconference example, when determining the subject of the activity comprises detecting an activity of the conferencing system terminal device 110, such as by detecting the conferencing system terminal device 110 is engaged in a videoconference, if an electronic communication had a subject related to a topic of the videoconference, the electronic communication and activity would be correlated.

In one or more embodiments, when the subject of the activity and the another subject of electronic communication are correlated and the electronic communication was received from the remote electronic device belonging to the another authorized user of the remote electronic device also engaged in the activity, the do not disturb override engine 212 causes the user interface 202 to present at least some of the electronic communication. In one or more embodiments, the do not disturb override engine 212 causes the user interface 202 to present the at least some of the electronic communication only when the another authorized user is a supervisor of the authorized user. Thus, in the example from FIG. 1 the electronic communication would be presented because Buster (606) was a supervisor of Mac.

In other embodiments, the do not disturb override engine 212 causes the user interface 202 to present the at least some of the electronic communication occurs only when the authorized user has designated the another authorized user as being allowed to override the do not disturb mode of operation. Thus, if a user designates a spouse, co-worker, supervisor, or other person as being allowed to override the do not disturb mode, in one or more embodiments the do not disturb override engine 212 allows such an override only when the electronic communication is received from a designated person.

In one or more embodiments, the videoconference subject detection engine 211 and/or the do not disturb override engine 212 can be operable with the one or more processors 203. In some embodiments, the one or more processors 203 can control the videoconference subject detection engine 211 and/or the do not disturb override engine 212. In other embodiments, the videoconference subject detection engine 211 and/or the do not disturb override engine 212 can operate independently from the one or more sensors 208. The videoconference subject detection engine 211 and/or the do not disturb override engine 212 can receive data from the various sensors. In one or more embodiments, the one or more processors 203 are configured to perform the operations of the videoconference subject detection engine 211 and/or the do not disturb override engine 212.

It is to be understood that FIG. 2 is provided for illustrative purposes only and for illustrating components of one conferencing system terminal device 110 in accordance with embodiments of the disclosure and is not intended to be a complete schematic diagram of the various components required for a conferencing system terminal device. Therefore, other conferencing system terminal devices in accordance with embodiments of the disclosure may include various other components not shown in FIG. 2 or may include a combination of two or more components or a division of a particular component into two or more separate components, and still be within the scope of the present disclosure.

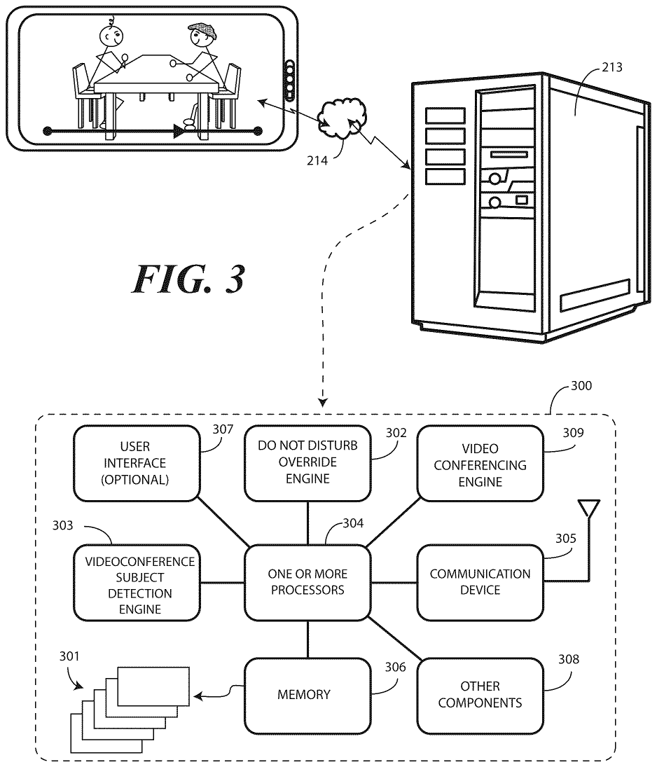

Turning now to FIG. 3, illustrated therein is one explanatory video conferencing system server complex 213 configured in accordance with one or more embodiments of the disclosure. An illustrative schematic block diagram 300 is also shown in FIG. 3.

As with the block diagram schematic (200) of FIG. 2, it is to be understood that the schematic block diagram 300 of FIG. 3 is provided for illustrative purposes only and for illustrating components of one explanatory conferencing system server complex 213 configured in accordance with one or more embodiments of the disclosure. Accordingly, the components shown in either FIG. 2 or FIG. 3 are not intended to be complete schematic diagrams of the various components required for a particular device, as other devices configured in accordance with embodiments of the disclosure may include various other components not shown in FIG. 2 or FIG. 3. Alternatively, other server complexes or conferencing system terminal devices configured in accordance with embodiments of the disclosure or may include a combination of two or more components or a division of a particular component into two or more separate components, and still be within the scope of the present disclosure.

In one or more embodiments the conferencing system server complex 213 can be configured with performing processor-intensive methods, operations, steps, functions, or procedures associated with the presentation, actuation, and management of dynamic, automatic, and electronic communications related to a videoconference during the videoconference. Illustrating by example, the conferencing system server complex 213 can be configured to, when the one or more processors 304 determine, from signals received from the communication device 305 when an electronic communication is received by a communication device of a conferencing system terminal device 110 in communication with the communication device 305 of the conferencing system server complex 213 across the network 214 is operating in a do not disturb mode of operation, subject matter of the videoconference.

For instance, the videoconference subject matter detection engine 303 can transcribe speech received by a user interface of the conferencing system terminal device to determine the subject matter of the activity. Similarly, a user interface of the conferencing system terminal device can receive user input defining the subject matter that is detected by the videoconference subject matter detection engine 303. In one or more embodiments, when an activity engaged in by an authorized user of a conferencing system terminal device in communication with the communication device 305 of the conferencing system server complex 213 and other subject matter of the electronic communication is correlated and, when the subject matter of the activity and the other subject matter of the electronic communication are correlated, a videoconference engine 309 can temporarily suspend the do not disturb mode of operation occurring in the conferencing system terminal device and cause the user interface of the conferencing system terminal device to present at least some of the electronic communication. Advantageously, this allows the conferencing system server complex 213 to perform the operations described with reference to FIGS. 1 and 2 above, thereby freeing up computing resources in the conferencing system terminal device itself.

In one or more embodiments, the conferencing system server complex 213 includes one or more memory devices 306, and one or more user interface devices 307, e.g., a display, a keyboard, a mouse, audio input devices, audio output devices, and alternate visual output devices. The conferencing system server complex 213 also includes a communication device 305. These components can be operatively coupled together such that, for example, the one or more processors 304 are operable with the one or more memory devices 306, the one or more user interface devices 307, the communication device 305, and/or other components 308 of the conferencing system server complex 213 in one or more embodiments.

The one or more processors 304 can include a microprocessor, a group of processing components, one or more ASICs, programmable logic, or other type of processing device. The one or more processors 304 can be configured to process and execute executable software code to perform the various functions of the conferencing system server complex 213.

The one or more memory devices 306 can optionally store the executable software code used by the one or more processors 304 in carrying out the operations of the videoconference system. The one or more memory devices 306 may include either or both of static and dynamic memory components. The one or more memory devices 306 can store both embedded software code and user data.

In one or more embodiments, the one or more processors 304 can define one or more process engines. For instance, the software code stored within the one or more memory devices 306 can embody program instructions and methods to operate the various functions of the conferencing system server complex 213, and also to execute software or firmware applications and modules such as the videoconference subject matter detection engine 303 and/or the video do not disturb override engine 302, which can be configured as one or more modules 301 stored in the memory 306.

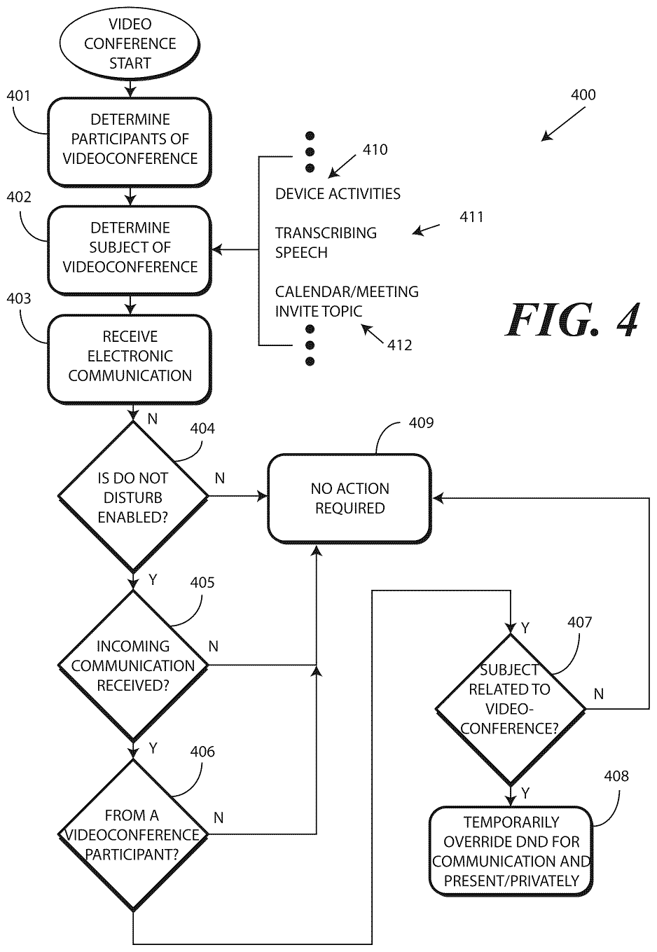

Turning now to FIG. 4, illustrated therein is another explanatory method 400 for an electronic device in accordance with one or more embodiments of the disclosure. The method 400 when one or more sensors of an electronic device determine that an authorized user of the electronic device is engaged in an activity.

In one or more embodiments, the determining the subject of the activity comprises determining an activity of the electronic device itself. For example, if the activity is a communication device of the electronic device being electronically in communication with one or more remote electronic devices engaged in a videoconference, step 401 can further comprise determining the identities of those other remote electronic devices to determine the participants of the videoconference.

Step 402 then determines the subject matter of the activity, which for explanatory purposes will be a videoconference. It should be noted that other activities can be substituted for the videoconference. Illustrating by example, embodiments of the disclosure could be applied to other activities, including while watching movies, playing sports such as a round of golf, while in meetings, and so forth. Other such activities suitable for embodiments of the disclosure will be obvious to those of ordinary skill in the art having the benefit of this disclosure.

The determination of the subject matter of the activity, which in this example is a videoconference, can occur in a variety of ways. In one or more embodiments, determining the subject matter of the videoconference comprises detecting a device activity 410. Illustrating by example, in one or more embodiments the device activity 410 may be a user interface of the electronic device receiving user input defining the subject of the activity.

In other embodiments, the subject of the videoconference can be determined at step 402 by transcribing speech 411 received by a user interface of the electronic device while an authorized user of the electronic device is engaged in the activity. Said differently, in one or more embodiments step 402 comprises transcribing speech 411 occurring during a videoconference. In other embodiments, step 402 can comprise ascertaining a subject found in a videoconference meeting notification 412 or calendar invitation stored in a memory of the electronic device. Other techniques for determining the subject of the videoconference at step 402 will be obvious to those of ordinary skill in the art having the benefit of this disclosure.

Step 403 then comprises receiving an electronic communication. Decision 404 determines whether the electronic device is operating in a do not disturb mode of operation.

Where it is not, no action is required at step 409. Otherwise, the method 400 moves to decision 405, which determines whether the electronic communication was received during the videoconference. Said differently, in one or more embodiments decision 405 comprises determining whether an electronic communication is received while an authorized user of the electronic device is engaged in the videoconference and the electronic device is operating in the do not disturb mode of operation.

Decision 406 comprises determining whether the electronic communication was received from a remote electronic device belonging to another authorized user of the remote electronic device also engaged in the videoconference. Decision 407 then determines whether a subject of the electronic communication is correlated to, or related to, the subject matter of the videoconference.

When the subject of the videoconference and the other subject of electronic communication are correlated, and the electronic communication was received from the remote electronic device belonging to the another authorized user of the remote electronic device also engaged in the videoconference, step 408 can comprise causing, by one or more processors, a user interface to present at least some of the electronic communication. Otherwise, no action is required at step 409.

As shown and described the method 400 of FIG. 4 allows for an electronic device configured with a processor system to detect when a videoconference is in progress and the device is in a do not disturb mode. The system can identify incoming communications from remote devices engaged in the same videoconference. The processor can evaluate whether these communications are materially related to the ongoing discussion by analyzing the content of the messages and comparing the content to the subject matter of the videoconference. If a correlation is found, the system can temporarily override the do not disturb mode to present the communication on the user interface.

In one or more embodiments, this presentation can be configured to appear only on the recipient's device, ensuring privacy even if the screen is shared. In another embodiment, the device may include a companion application on a smartwatch or tablet, allowing the communication to be discreetly displayed on these devices instead. The system can also be adapted to use artificial intelligence to transcribe and analyze speech during the conference, further enhancing the system's ability to determine the relevance of incoming messages. Additionally, user settings can be customized to allow only certain participants, such as supervisors, to override the do not disturb mode, providing flexibility and control over the communication flow during meetings.

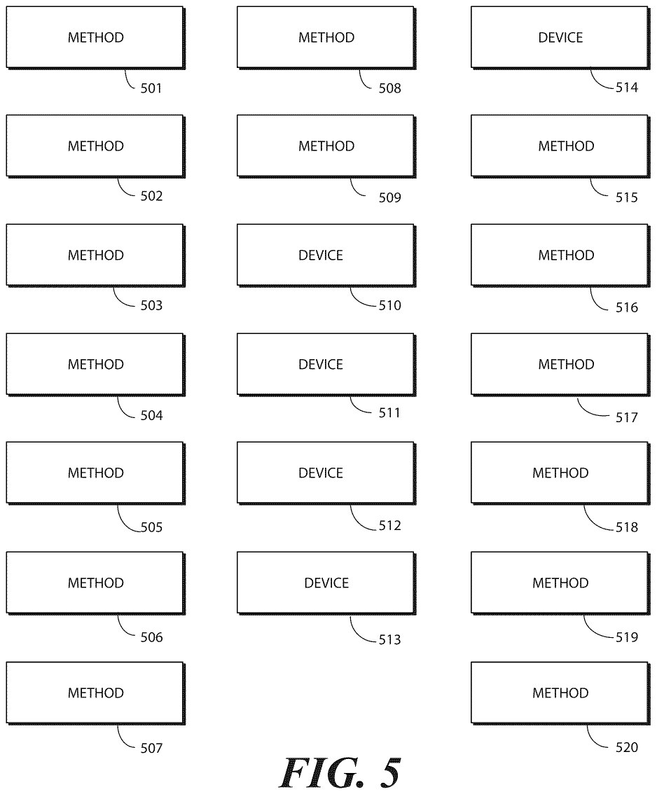

Turning now to FIG. 5, illustrated therein are various embodiments of the disclosure. The embodiments of FIG. 5 are shown as labeled boxes in FIG. 5 due to the fact that the individual components of these embodiments have been illustrated in detail in FIGS. 1-4, which precede FIG. 5. Accordingly, since these items have previously been illustrated and described, their repeated illustration is no longer essential for a proper understanding of these embodiments.

Thus, the embodiments are shown as labeled boxes. At 501, a method in an electronic device comprises detecting, with one or more processors during a videoconference, a communication device electronically in communication with one or more remote electronic devices engaged in the videoconference. At 501, the method comprises receiving, with a communication device operable with the one or more processors, an electronic communication while the videoconference is occurring, and the electronic device is operating in a do not disturb mode of operation.

At 501, the method comprises determining, by the one or more processors, whether the electronic communication is materially related to subject matter of the videoconference. At 501, the method comprises and where the electronic communication is materially related to the subject matter of the videoconference, temporarily overriding, by the one or more processors, the do not disturb mode of operation for the electronic communication and presenting, by the one or more processors on a user interface of the electronic device, at least some of the electronic communication.

At 502, the determining whether the electronic communication is materially related to the subject matter of the videoconference of 501 comprises determining whether the electronic communication is received from a remote electronic device engaged in the videoconference. At 503, the determining whether the electronic communication is materially related to the subject matter of the videoconference at 502 comprises determining whether a subject of the electronic communication is materially related to the subject matter of the videoconference.

At 504, the presenting the at least some of the electronic communication at 503 comprises presenting the at least some of the electronic communication on a display of the electronic device. At 505, the presenting the at least some of the electronic communication of 504 comprises presenting the at least some of the electronic communication on only the display of the electronic device without presenting the at least some of the electronic communication on any of the one or more remote electronic devices. At 506, the presenting the at least some of the electronic communication of 503 comprises presenting the at least some of the electronic communication on a display of a companion electronic device in communication with the electronic device.

At 507, the method of 501 further comprises identifying, by the one or more processors, the subject matter of the videoconference. At 508, the identifying the subject matter of the videoconference of 507 comprises transcribing, by the one or more processors, speech occurring during the videoconference. At 509, the identifying the subject matter of the videoconference comprises of 507 ascertaining, by the one or more processors, a subject found in a videoconference meeting notification stored in a memory of the electronic device.

At 510, an electronic device comprises one or more sensors, a communication device, a user interface, and one or more processors operable with the one or more sensors, the communication device, and the user interface. At 501, the one or more processors determine, from signals received from the one or more sensors when an electronic communication is received by the communication device while the electronic device is operating in a do not disturb mode of operation, subject matter of an activity engaged in by an authorized user of the electronic device and other subject matter of the electronic communication and, when the subject matter of the activity and the other subject matter of the electronic communication are correlated, temporarily suspend the do not disturb mode of operation to cause the user interface to present at least some of the electronic communication.

At 511, the activity of 510 is a videoconference. At 512, the one or more processors of 511 only cause the user interface to present the at least some of the electronic communication when the electronic communication is received from a remote electronic device engaged in the videoconference.

At 513, the electronic communication of 512 comprises a chat communication occurring within the videoconference. At 514, the one or more processors of 513 cause the user interface to present the at least some of the electronic communication on the user interface while precluding at least one other remote electronic device engaged in the videoconference from presenting any of the electronic communication.

At 515, a method in an electronic device comprises determining, by one or more sensors, that an authorized user of the electronic device is engaged in an activity while the electronic device is operating in a do not disturb mode of operation. At 515, the method comprises receiving, by a communication device while the authorized user of the electronic device is engaged in the activity and the electronic device is operating in the do not disturb mode of operation, an electronic communication.

At 515, the method comprises determining, by one or more processors a subject of the activity, another subject of the electronic communication, and whether the electronic communication was received from a remote electronic device belonging to another authorized user of the remote electronic device also engaged in the activity. At 515, when the subject of the activity and the another subject of electronic communication are correlated and the electronic communication was received from the remote electronic device belonging to the another authorized user of the remote electronic device also engaged in the activity, the method comprises causing, by the one or more processors, a user interface to present at least some of the electronic communication.

At 516, the determining the subject of the activity of 515 comprises detecting an activity of the electronic device. At 517, the determining the subject of the activity of 515 comprises transcribing, by the one or more processors, speech received by the user interface while the authorized user is engaged in the activity. At 518, the determining the subject of the activity of 515 comprises the user interface receiving user input defining the subject of the activity.

At 519, the causing the user interface to present the at least some of the electronic communication at 515 occurs only when the another authorized user is a supervisor of the authorized user. AT 520, the causing the user interface to present the at least some of the electronic communication of 515 occurs only when the authorized user has designated the another authorized user as being allowed to override the do not disturb mode of operation.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in other embodiments the electronic device comprises a set of sensors, such as microphones and cameras, that detect user engagement in a videoconference. These sensors work in tandem with a communication device and a user interface to manage incoming electronic communications.

The processors within the device can then be programmed to assess the relevance of these communications by analyzing the subject matter of the videoconference, which can be determined through speech transcription or calendar data. If a communication is deemed relevant, the device temporarily suspends the do not disturb mode to display the message on the user interface. In another embodiment, the device includes a companion application on a smartwatch or tablet, allowing communications to be discreetly displayed on these devices, ensuring privacy even if the main screen is shared. The system can be configured to allow only certain participants, such as supervisors, to override the do not disturb mode, providing flexibility and control over communication flow during meetings. Additionally, the device may utilize AI to enhance the detection and analysis of relevant communications, further improving user engagement and productivity.

What's more, in still other embodiments the system can receive electronic communications through a communication device and determine the subject of the activity by transcribing speech or analyzing calendar data. If the communication is from another participant in the videoconference and is relevant to the ongoing discussion, the device temporarily overrides the do not disturb mode to present the message on the user interface. This presentation can be configured to appear only on the recipient's device, ensuring privacy even if the screen is shared.

In another embodiment, the device may include a companion application on a smartwatch or tablet, allowing communications to be discreetly displayed on these devices. The system can also be adapted to use artificial intelligence to enhance the detection and analysis of relevant communications. Additionally, user settings can be customized to allow only certain participants, such as supervisors, to override the do not disturb mode, providing flexibility and control over the communication flow during meetings.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
detecting, with one or more processors during a videoconference, a communication device electronically in communication with one or more remote electronic devices engaged in the videoconference;
receiving, with a communication device operable with the one or more processors, an electronic communication while the videoconference is occurring, and the electronic device is operating in a do not disturb mode of operation;
determining, by the one or more processors, whether the electronic communication is materially related to subject matter of the videoconference; and
where the electronic communication is materially related to the subject matter of the videoconference, temporarily overriding, by the one or more processors, the do not disturb mode of operation for the electronic communication and presenting, by the one or more processors on a user interface of the electronic device, at least some of the electronic communication.

2. The method of claim 1, wherein the determining whether the electronic communication is materially related to the subject matter of the videoconference comprises determining whether the electronic communication is received from a remote electronic device engaged in the videoconference.

3. The method of claim 2, wherein the determining whether the electronic communication is materially related to the subject matter of the videoconference comprises determining whether a subject of the electronic communication is materially related to the subject matter of the videoconference.

4. The method of claim 3, wherein the presenting the at least some of the electronic communication comprises presenting the at least some of the electronic communication on a display of the electronic device.

5. The method of claim 4, wherein the presenting the at least some of the electronic communication comprises presenting the at least some of the electronic communication on only the display of the electronic device without presenting the at least some of the electronic communication on any of the one or more remote electronic devices.

6. The method of claim 3, wherein the presenting the at least some of the electronic communication comprises presenting the at least some of the electronic communication on a display of a companion electronic device in communication with the electronic device.

7. The method of claim 1, further comprising identifying, by the one or more processors, the subject matter of the videoconference.

8. The method of claim 7, wherein the identifying the subject matter of the videoconference comprises transcribing, by the one or more processors, speech occurring during the videoconference.

9. The method of claim 7, wherein the identifying the subject matter of the videoconference comprises ascertaining, by the one or more processors, a subject found in a videoconference meeting notification stored in a memory of the electronic device.

10. An electronic device, comprising:
one or more sensors;
a communication device;
a user interface; and
one or more processors operable with the one or more sensors, the communication device, and the user interface;
wherein the one or more processors determine, from signals received from the one or more sensors when an electronic communication is received by the communication device while the electronic device is operating in a do not disturb mode of operation, subject matter of an activity engaged in by an authorized user of the electronic device and other subject matter of the electronic communication and, when the subject matter of the activity and the other subject matter of the electronic communication are correlated, temporarily suspend the do not disturb mode of operation to cause the user interface to present at least some of the electronic communication.

11. The electronic device of claim 10, wherein the activity is a videoconference.

12. The electronic device of claim 11, wherein the one or more processors only cause the user interface to present the at least some of the electronic communication when the electronic communication is received from a remote electronic device engaged in the videoconference.

13. The electronic device of claim 12, wherein the electronic communication comprises a chat communication occurring within the videoconference.

14. The electronic device of claim 13, wherein the one or more processors cause the user interface to present the at least some of the electronic communication on the user interface while precluding at least one other remote electronic device engaged in the videoconference from presenting any of the electronic communication.

15. A method in an electronic device, the method comprising:
determining, by one or more sensors, that an authorized user of the electronic device is engaged in an activity while the electronic device is operating in a do not disturb mode of operation;
receiving, by a communication device while the authorized user of the electronic device is engaged in the activity and the electronic device is operating in the do not disturb mode of operation, an electronic communication;
determining, by one or more processors:
a subject of the activity;
another subject of the electronic communication; and
whether the electronic communication was received from a remote electronic device belonging to another authorized user of the remote electronic device also engaged in the activity; and
when the subject of the activity and the another subject of electronic communication are correlated and the electronic communication was received from the remote electronic device belonging to the another authorized user of the remote electronic device also engaged in the activity, causing, by the one or more processors, a user interface to present at least some of the electronic communication.

16. The method of claim 15, wherein the determining the subject of the activity comprises detecting an activity of the electronic device.

17. The method of claim 15, wherein the determining the subject of the activity comprises transcribing, by the one or more processors, speech received by the user interface while the authorized user is engaged in the activity.

18. The method of claim 15, wherein the determining the subject of the activity comprises the user interface receiving user input defining the subject of the activity.

19. The method of claim 15, wherein the causing the user interface to present the at least some of the electronic communication occurs only when the another authorized user is a supervisor of the authorized user.

20. The method of claim 15, wherein the causing the user interface to present the at least some of the electronic communication occurs only when the authorized user has designated the another authorized user as being allowed to override the do not disturb mode of operation.
